(19) United States
(12) Patent Application Publication
(10) Pub. No.: US 2007/0082997 A1
(43) Pub. Date: Apr. 12, 2007

(54) Composite door structure and method of making same, and composite door and method of making same

(76) Inventors: James P. Pfau, Kirkland, IL (US); Dilpreet S. Bajwa, Fayetteville, AR (US); Manish Gupta, Evanston, IL (US); Michael J. MacDonald, Batavia, IL (US); Steven K. Lynch, St. Charles, IL (US); Gary Fagan, Huntersville, NC (US); Richard H. Kon, Cornelius, NC (US)

Correspondence Address: BERENATO, WHITE & STAVISH, LLC, 6550 ROCK SPRING DRIVE, SUITE 240, BETHESDA, MD, 20817, US

(21) Appl. No.: 10/573,442

(22) PCT Filed: Aug. 20, 2004
(86) PCT No.: PCT/US04/27079

§ 371 Date: Nov. 28, 2006

Related U.S. Application Data
(60) Provisional application No. 60/496,404, filed on Aug. 20, 2003.

(51) Int. Cl. C08K 3/34; C08K 3/40

(52) U.S. Cl. 524/449; 524/494

(57) ABSTRACT

A composite door structure especially suitable for use as a door facing is provided. The structure comprises about 40 weight percent to about 80 weight percent thermoplastic polymer; up to about 30 weight percent glass fibers; and a filler selected from (a) about 5 weight percent to about 40 weight percent mineral filler and (b) about 10 weight percent to about 50 weight percent organic fibrous additive. A composite door comprising the door facing, and methods of making the same are also provided.

### CROSS-REFERENCE TO RELATED APPLICATION AND CLAIM TO PRIORITY

This application claims the benefit of provisional application 60/496,404 filed in the United States Patent and Trademark Office on Aug. 20, 2003, the disclosure of which is incorporated herein by reference and priority to which is claimed pursuant to 35 U.S.C. § 120.

### BACKGROUND OF THE INVENTION

1. Field of the Invention

The present invention relates to a thermoplastic composition suitable for making a composite door structure, such as a door facing, as well as a composite door structure and composite door made therewith. The present invention also relates to methods of making the composition, composite door structure, and composite door.

2. Description of the Related Art

Doors are increasingly being manufactured from plastic components. Typical door assemblies comprise a pair of compression molded exterior skins, frequently having wood grain patterns on their outer surfaces, which are mounted on a rectangular frame that separates and supports the skins in spaced relationship. The hollow space between the skins typically is filled with foam, such as a polyurethane foam. These composite door assemblies resist rot and corrosion and are generally better insulators than solid wood, wood composite or metal doors. Because of material costs and manufacturing efficiencies, polymer composite door assemblies are considerably less expensive to manufacture than solid wood doors and can be designed to provide a reasonable facsimile of a wood grain door.

A typical compression molding process used in manufacturing currently available molded door-skins involves placing a predetermined weight of sheet molding compound (SMC) within a lower mold half. An upper mold half is then advanced into engagement with the lower mold half to cause the SMC to conform to the shape of the mold. The mold halves are heated to facilitate flow and affect the thermosetting reaction.

A drawback to the use of thermosetting resins is that, after setting, the thermosetting process generally cannot be reversed. Any finished material that is flawed, scrapped or otherwise rejected cannot be reused, thereby reducing manufacturing and cost efficiencies. Further, the rejected material must be disposed of, typically in a relatively expensive landfill.

The selection of a suitable alternative material for thermosetting resins is difficult. The selected material should be dimensionally stable in response to temperature fluctuations encountered during use of the end product. For example, the surface temperature of the door facing behind a storm door may reach temperatures in excess of 82° C. (180° F.) in response to direct sunlight exposure. The surface temperature of a dark painted door behind a full view storm door can reach up to 116° C. (240° F.). Consequently, many materials undergo considerable thermal expansion when used on an exterior door used in association with a storm door.

Efforts have been made to utilize thermoplastic materials as substitutes for the thermosetting materials in the manufacture of door skins, but those efforts have so far been unsuccessful for a variety of reasons. Polypropylene, one common thermoplastic material, has a relatively inert surface (low surface energy), which substantially precludes adhesion by adhesives used to bond the door skin to the door frame and coatings, such as paint. Additionally, the coefficient of thermal expansion is such that the exterior skin, which is exposed to the elevated temperature behind the storm door, may expand to such an extent relative to the relatively cool interior skin as to distort the door.

Additionally, in a simple compression molding process as described above, the resulting molded structure including structural elements molded therein should be of a relatively consistent thickness. The addition of relatively thicker structural elements in the door skin or the addition of structural elements which require the displacement of a considerable amount of molding material away from the face of the door skin requires the use of secondary molding steps to build up the structural element. Such secondary molding steps add significantly to the molding cost and the cost of the finished product. Accordingly, it is desirable that the selected alternative material reduces or avoids costs associated with such secondary molding steps.

### SUMMARY OF THE INVENTION

An object of the invention is to provide a thermoplastic composite door structure that possesses substantially comparable if not improved physical properties compared to a thermosetting door facing, while overcoming the above-described manufacturing and environmental inefficiencies of thermosets.

It is another object of the invention to provide a method of making a composite door structure that utilizes existing technology, preferably so as to not require significant modifications to existing manufacturing apparatuses, yet which overcomes the above-mentioned manufacturing and environmental inefficiencies of thermosets.

Another object of the invention is to provide a composite door comprising a composite door structure that possesses substantially comparable if not improved physical properties compared to a thermosetting door facing, while overcoming the above-described manufacturing and environmental inefficiencies of thermosets.

In accordance with the purposes of the invention as embodied and broadly described in herein, an aspect of this invention provides a composite door structure (or component) comprising about 40 weight percent to about 80 weight percent thermoplastic polymer, about 5 weight percent to about 30 weight percent glass fibers when glass fibers are provided for structural reinforcement, and a filler selected from (a) about 5 weight percent to about 40 weight percent mineral filler and (b) about 10 weight percent to about 50 weight percent organic fibrous additive. The composite door structure of this aspect preferably comprises a molded door facing, sometimes called a door skin.

According to another aspect of the invention, there is provided a door comprising a frame having opposite first and second sides; first and second molded door facings fixed to the first and second sides, respectively; and a core component situated between the first and second molded door facings. At least one of the molded door facings comprises about 40 weight percent to about 80 weight percent thermoplastic polymer, about 5 weight percent to about 30 weight percent glass fibers when glass fibers are provided for structural reinforcement, and a filler selected from (a) about 5 weight percent to about 40 weight percent mineral filler and (b) about 10 weight percent to about 50 weight percent organic fibrous additive.

Yet another aspect of the invention is directed to a method of making a composite door structure (or component) by the steps of extruding a composition comprising about 40 weight percent to about 80 weight percent thermoplastic polymer, about 5 weight percent to about 30 weight percent glass fibers when glass fibers are provided for structural reinforcement, and a filler selected from (a) about 5 weight percent to about 40 weight percent mineral filler and (b) about 10 weight percent to about 50 weight percent organic fibrous additive; and forming the extruded composition into a composite door skin structure.

A further aspect of the invention includes a method of making a door, comprising the steps of extruding a composition comprising about 40 weight percent to about 80 weight percent thermoplastic polymer, about 5 weight percent to about 30 weight percent glass fibers when glass fibers are provided for structural reinforcement, and a filler selected from (a) about 5 weight percent to about 40 weight percent mineral filler and (b) about 10 weight percent to about 50 weight percent organic fibrous additive; forming the extruded composition into a composite door skin structure, the composite door structure comprising a first door skin; and assembling the first door skin, a second door skin, a foam core, and a peripheral frame into a door in which the first and second door skins are fixed on opposite sides of a peripheral frame and the foam core is situated between the first and second door skins.

In yet another aspect of the invention a method of making a door includes the steps of extruding a composition comprising about 40 weight percent to about 80 weight percent thermoplastic polymer, about 5 weight percent to about 30 weight percent glass fibers when glass fibers are provided for structural reinforcement, and a filler selected from (a) about 5 weight percent to about 40 weight percent mineral filler and (b) about 10 weight percent to about 50 weight percent organic fibrous additive; forming the extruded composition into a plurality of the composite door skin structures, the composite door skin structures comprising a first door skin and a second door skin; and assembling the first door skin, the second door skin, a foam core, and a peripheral frame into a door in which the first and second door skins are fixed on opposite sides of the peripheral frame and the foam core is situated between the first and second door skins.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a schematic diagram of a system suitable for carrying out a method of an embodiment of the present invention;

FIG. 2 is an elevational view of an exterior surface of a door facing according to an embodiment of the present invention;

FIG. 3 is an elevational view of an interior surface of a door facing according to another embodiment;

FIG. 4 is a cross-sectional view of a rib according to another embodiment;

FIG. 5 is a fragmentary cross-sectional view of a door according to another embodiment; and

FIG. 6 is a cross-sectional view of a door according to an embodiment having a core component.

### DETAILED DESCRIPTION OF PREFERRED EMBODIMENTS AND METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

According to an embodiment of the invention, a composition is provided comprising between about 40 weight percent to about 80 weight percent thermoplastic polymer, up to about 30 weight percent glass fibers (more particularly about 5 weight percent to about 30 weight percent when glass fibers are utilized for structural reinforcement), and a filler selected from (a) about 5 weight percent to about 40 weight percent mineral filler and (b) about 10 weight percent to about 50 weight percent organic fibrous additive. The composition may comprise filler (a), filler (b), a combination of fillers (a) and (b), or (a) and/or (b) in combination with other fillers.

According to a preferred embodiment, the thermoplastic polymer is present in an amount of about 50 weight percent to about 80 weight percent. According to another preferred embodiment, the glass fibers constitute between about 10 weight percent and 30 weight percent, more preferably about 10 weight percent to about 20 weight percent of the composition. The mineral filler, if present, preferably constitutes about 10 weight percent to about 40 weight, more preferably about 10 weight percent to about 30 weight percent, still more preferably about 20 weight percent to about 30 weight percent of the composition. The organic fibrous additive, if present, preferably constitutes about 10 weight percent to about 50 weight percent of the composition, more preferably about 10 weight percent to about 30 weight percent of the composition.

The polymeric constituent is preferably a thermoplastic polymer, and more preferably selected from polypropylene (PP) and polystyrene (PS). The polypropylene polymer is preferably an impact grade polypropylene made from a composition comprising ethylene and propylene. For example, the impact grade polypropylene may contain less than 5% by weight ethylene, although other concentrations are possible. A suitable impact grade polypropylene is available from Huntsman Corporation of Salt Lake City, Utah, and Basell Polyolefins Company of Hoofddorp, The Netherlands. The polystyrene polymer may be impact grade or general-purpose polystyrene. Other thermoplastic polymers that may be used alone or in combination with PP, PS, or each other include polyethylene, styrene-acrylonitrile copolymers (SAN), acrylonitrile-styrene-acrylate terpolymers (ASA), styrene maleic anhydride (SMA), nylon, acrylics, poly(vinyl chloride) (PVC), polycarbonates, poly(ethylene terephthalate) (PET), acrylonitrile-butadiene-styrene terpolymers (ABS), acetal, and polyesters. Other polymeric materials may be included as well. For example, ethylene propylene diene monomer (EPDM) polymer or polymers possessing similar impact resistant properties may be included.

The mineral filler may be mica, including muscovite mica or phlogopite mica. Other fillers may also be used alone or in combination with mica include, for example, talc. The selected filler preferably undergoes minimal shrinkage due to thermal fluctuations. Consequently, the mineral filler stabilizes the thermal and mechanical properties of a resultant product, and minimizes bending or warping of the product due to thermal fluctuations. In addition, fillers such as mica are relatively inexpensive compared to other reinforcing components, such as glass fibers. As such, it is often desirable to incorporate at least as much mica as glass in the composition.

The glass fibers may be either treated or untreated. The fibers may have a length in a range of about 3 mm to about 7.62 cm (about 3.0 inches). The glass may be blended into the composition, and chopped into fibers of variable length during an extrusion process. Alternatively, the fibers may have a substantially uniform length. Pre-chopped glass fibers having a particular length may also be used. The chopped fibers are mixed into the composition during blending.

The composition may also include additional components, such as antioxidants, antistatic metals, and/or colorants. A suitable antioxidant is Irganox™ B 225 from Cieba Specialty Chemicals Corporation. The composition may further optionally include a coupling agent for improving adhesion between components of the composition. It is contemplated that the coupling agent may constitute 0.5 to 5 percent by weight of the composition. An exemplary coupling agent comprises maleated polypropylene.

Suitable organic fibrous additives include wood powder or wood flour, such as provided by relatively small particles of pine and other suitable inexpensive woods, such as oak, cherry, maple, gum and combinations of the same or other woods. Other fibrous organic materials may also be used, including but not limited to straw, rice husks, and knaff. The organic fibrous additive component may comprise a mixture of wood and other fibrous organic materials. The additive preferably is sized to pass through an 80 mesh sieve, although different sizes are considered to be well within the scope of the present invention. The organic fibrous material may be a by-product of other wood manufacturing processes. Accordingly, the organic fibrous material may be considered to be part of the waste stream of a manufacturing facility. Use of waste material has significant cost and environmental benefits.

The composition is particularly effective for use as a composite door structure, especially a molded door facing. Molding of the composition into a suitable door-facing configuration may be accomplished via compression molding, which is described in further detail below.

The composition preferably is formulated to possess one or more, and more preferably all, of the following thermal and mechanical properties: a melt flow index at 230° C. of between about 0.5 g/10 min to about 500 g/10 min; a coefficient of thermal expansion of between about 20×10⁻⁶/° C. to about 40×10⁻⁶/° C.; a stiffness of between about 400,000 to about 2.0 million pounds per square inch (psi); an impact strength of between about 1.5 foot pounds to about 7.5 foot pounds; and a toughness of between about 5.0 foot pounds to about 25.0 foot pounds.

The coefficient of thermal expansion is greatly influenced by the wood and mineral fillers and the glass fibers, which minimize shrinkage of the composition after pressing. Any shrinkage that does occur may be made relatively uniform by uniformly distributing the mineral filler and glass fibers throughout the composition. Bending and/or warping of articles formed from the composition are thereby minimized.

Exemplary formulations of embodied compositions are set forth below in Table 1:

TABLE 1

| | Blend 1 | Blend 2 | Blend 3 |
|---|---|---|---|
| Ingredient | (wt %) | (wt %) | (wt %) |
| glass fibers | 10 | 20 | 10 |
| mica | 20 | 20 | 0 |
| polypropylene obtained from Basell | 68.8 | 58.8 | 47 |
| antioxidant (Irganox ™ B 225, | 0.2 | 0.2 | — |
| Cieba Specialty Chemicals Corp.) | | | |
| maleated polypropylene | — | — | 3 |
| wood flour | — | — | 40 |

Tables 2 and 3 set forth measured properties for Blends 1 and 3, respectively, wherein all properties were measured at 22° C. (72° F.) unless otherwise indicated:

TABLE 2

| Property | Average | STD |
|---|---|---|
| Coefficient of Thermal Expansion (×10⁻⁶/° C.) | 40 | 5 |
| Unnotched Impact (ft · lbs/inch) | 2.9 | 1.0 |
| [ASTM D256, Method A-Unnotched] | | |
| Flexural Young's Modulus (kpsi) | 1037 | 141 |
| Flexural Maximum Stress (psi) | 7864 | 1141 |
| Tensile Young's Modulus (kpsi) | 1137 | 152 |
| Tensile Strain at Break (%) | 1.0 | 0.2 |
| Tensile Toughness to Break (psi) | 40 | 14 |
| Tensile Maximum Stress (psi) | 5822 | 1081 |

TABLE 3

| Property | Average | STD |
|---|---|---|
| Specific Gravity | 1.04 | 0.01 |
| Flexural Modulus (kpsi) | 640 | 157 |
| Flexural Maximum Stress (psi) | 5768 | 1182 |
| CTE (−29 TO 70° C. (10⁻⁶/° C.) | 23 | — |

Additional embodiments and related properties are set forth in Table 4, in which polystyrene was selected as the thermoplastic.

TABLE 4

| | Blend 4 | Blend 5 | Blend 6 | Blend 7 |
|---|---|---|---|---|
| Glass (wt %) | 20 | 10 | 15 | 10 |
| Mica (wt %) | 20 | 30 | 20 | 20 |
| PS (wt %) | 60 | 60 | 65 | 70 |
| Charge type | Sheet | Log | Log | Log |
| Caliper (inch) | 0.133 (0.007) | 0.135 (0.007) | 0.171 (0.010) | 0.155 (0.03) |
| Specific Gravity | 1.39 (0.01) | 1.40 (0.02) | 1.34 (0.01) | 1.29 (0.01) |
| Flexural-Modulus (kpsi) | 1879 (150) | 2094 (106) | 1711 (131) | 1709 (77) |
| Tensile-Young's Modulus (kpsi) | 1696 (90) | 2043 (282) | 2037 (733) | 1579 (289) |
| Unnotched Impact (ft · lb/in) | 1.40 (0.77) | 0.83 (0.20) | 1.75 (0.48) | 1.72 (0.57) |
| CTE (×10⁻⁶/° C.) −29 to 70° C. | 25 (4) | 25 (2) | 28 (4) | 29 (3) |

* values in parentheses are standard deviations

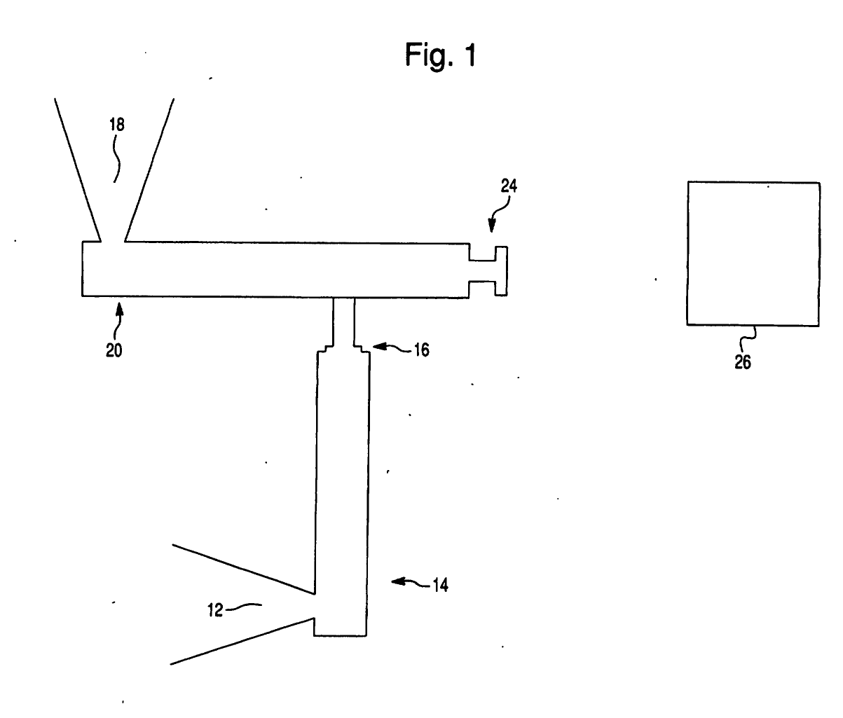

An embodiment of a system 10 suitable for blending and mixing the ingredients comprising the embodied compositions is best shown in FIG. 1. A first stage of the system 10 comprises a first extruder 14 having a first feed hopper 12 and a first outlet 16. According to an embodiment of the invention, the thermoplastic polymer (e.g., polypropylene) and mineral filler (e.g., mica) are fed into the first feed hopper 12. Additional additives may also be fed into first feed hopper 12, including antioxidants, colorants, or other filler materials such as talc. The polypropylene, mica and additives may be fed into first feed hopper 12 in dry form. First feed hopper 12 gravimetrically feeds the components into the first extruder 14.

The first extruder 14 is preferably a compounding extruder, which melts and blends the thermoplastic, filler and additives. Barrel diameter is dependent on the desired output rate. The processing temperature in the first extruder 14 is preferably between about 182.2° C. (about 360° F.) to about 260° C. (about 500° F.).

The second processing stage of the system 10 comprises a second extruder 20, second feed hopper 18 and an outlet die 24. Glass fibers or spooled glass is fed into second extruder 20 via the second feed hopper 18. The extruded material exiting the first outlet 16 of the first stage is fed into the second extruder 20, which further blends the polymer, filler, additives with glass material. The glass feed may be chopped into fibers having a variable length of between about 3 mm to about 7.62 cm. Alternatively, all of the fibers may have a substantially uniform length within the disclosed range. Following blending in the second extrusion stage, the resultant molten composition exits through the outlet die 24 at the end of the downstream second extruder 20.

The second extruder 20 provides for relatively low shear mixing compared to the first extruder 14. The barrel diameter of the second extruder 20 is again dependent on the desired output. The processing temperature of the second extruder 20 is preferably between about 165.6° C. (about 330° F.) to about 237.8° C. (about 460° F.). Preferably, the temperature of the glass in the second extruder 20 is between about 171.1° C. (about 340° F.) to about 193.3° C. (about 380° F.). The melt temperature of the composition exiting outlet die 24 preferably is between about 196.1° C. (about 385° F.) to about 287.8° C. (about 550° F.).

The configuration and settings of the first and second extruders 14, 20 may vary depending on the melt flow index and other properties of the particular composition subjected to blending, and the desired thermal and mechanical properties of the composition. Suitable extruder apparatuses are available, for example, from Composite Products, Inc. (CPI) of Winona, Minn.; Dieffenbacher GmbH & Co. of Eppingen, Germany; Composite Technologies Co., LLC, Dayton Ohio.

Upon exiting the extrusion die 24, the molten composition may be transferred in billet form to a compression molding press 26. The press 26 may include door facing die molds having a cavity and a core. The press is maintained at a temperature and pressure sufficient to allow the thermoplastic composition to conform to the shape of the mold and solidify. For example, the core and cavity temperatures are preferably maintained between about 60° C. (about 140° F.) and about 87.8° C. (about 190° F.). The press 26 compresses the charge into an article, such as a door facing or other composite door structure. Preferably, the composition is subjected to between about 54.4 atm (about 800 psi) to about 68.0 atm (about 1000 psi) for between about 30 to about 60 seconds. Pressing temperatures and pressures may vary depending on the constituents and concentrations of the composition.

During compression, the glass fibers tend to align longitudinally relative to the length of the billets. A uniform orientation of the glass fibers leads to a variance in physical and mechanical properties of the molded article due to a differential in shrinkage values of the glass compared to the polymer component in the composition. This, in turn, may lead to warpage of the molded article. Therefore, the dimensions of the billets and billet placement on the mold die are controlled, to maximize random orientation of glass fibers. Warpage of the article is thereby minimized. In addition, uniform physical and mechanical properties are achieved.

On the other hand, certain thermoplastics, such as polystyrene having a high glass transition temperature, may develop high internal stresses during compression molding.

These internal stresses may be relieved at elevated temperatures, e.g., about 82° C. (about 180° F.) or higher, such as encountered between a door and storm door during summertime. To relieve such internal stresses, the pressed composite door structure may be subjected to an annealing operation or the like.

Billet placement is dependent on the configuration of the composite door structure being formed. For example, billet placement for door facings may vary depending on whether the door facing is a planar facing, a paneled facing, or a facing having an opening for a window or lite. Proper billet placement may be determined using a computer-engineering program that simulates melt flow of the composition based on billet size, shape and orientation. An example of such a program is CADPRESS of Madison Group (Madison, Wis.). The orientation of windows and ovalos (e.g., tapering molded portions around windows and panels) forming panels is also taken into account.

Because the glass fibers align with the billet, the orientation and distribution of the glass fibers is also determined by billet placement and orientation and melt flow simulation. Thus, billet placement helps to control glass fiber distribution and orientation.

A random orientation and relatively uniform distribution of glass fibers in the molded article provides uniform thermal and mechanical properties. Shrinkage and warpage are minimized. In addition, a relatively even distribution of glass fibers results in an article with excellent surface quality.

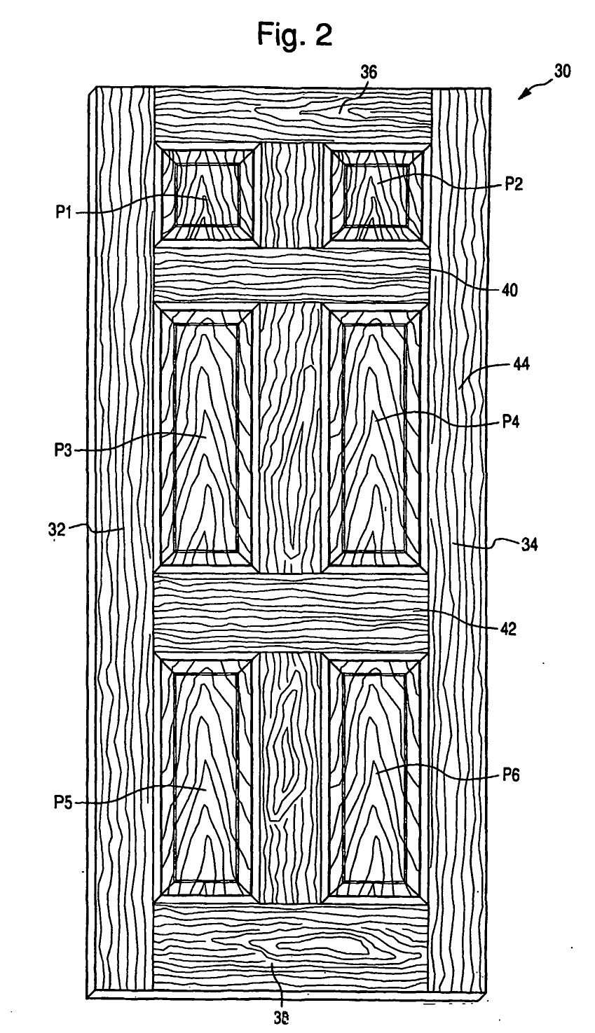

In an embodiment shown in FIG. 2, a multi-panel (six-panel, as shown) door facing 30 is formed from four billets of an embodiment of the disclosed composition. As such, the door facing 30 comprises between about 40% to about 80% by weight thermoplastic (e.g., polypropylene), between about 10% to about 30% by weight mineral filler, and between about 10% to about 30% by weight glass fibers. Door facing 30 may also include additives such as antioxidants, antistatic materials, and/or colorants.

The door facing 30 includes six panel portions P1, P2, P3, P4, P5, P6, two stile portions 32, 34, two outer rail portions 36, 38, and two intermediate rail portions 40, 42. Four billets are placed on the mold die of press 26 perpendicular to the stile-forming areas of the mold die, and parallel with the rail-forming areas of the mold die. Each billet is approximately 600-900 mm in length, approximately 150-250 mm in width, and approximately 5-10 mm in height. The four billets are spaced from the perimeter of the mold die of press 26 about 60 mm to about 80 mm. The billets are substantially equidistant from and parallel to each other. The resulting door facing has a glass fiber distribution that is substantially uniform. However, the glass fibers have a reduced longitudinal orientation.

Less oriented glass fiber orientation may be achieved with other billet placement configurations. In another embodiment, a single billet of the composition is arranged on the die in a serpentine or ‘S’ pattern. In another embodiment, a single billet is arranged diagonally on the die. In another embodiment, two billets are arranged on the die in a ‘T’ configuration. In another embodiment, three billets are arranged on the die in an ‘H’ configuration. Therefore, one, two, three, four or more billets may be arranged on the die in a variety of configurations.

As the billets are compressed, the molten composition gradually cools. However, the composition is compressed into the desired shape before cooling is completed. After the molded article is formed and sufficiently cooled, press 26 is opened, and the article is removed from between the mold dies.

Another embodiment of the invention provides a thermoforming process for molding the composite door structure. According to this embodiment, the composition is mixed and extruded into sheets of relatively small thickness, such as about 2 mm to about 4 mm. The sheets are extruded at appropriate widths and cut to appropriate lengths for various size doors. The sheets are then thermoformed, preferably through vacuum forming. The sheets may also be formed through pressure or compression molding with matched tooling. The forming imparts a three-dimensional door surface on the sheet, thus creating a thin door facing from the sheet.

Because thermoplastics are used in the embodiments described herein, if the molded article includes defects that render the article unacceptable, the article may be recycled, e.g., re-melted and re-molded.

Door facing 30 may include an exterior surface 44 having formed therein a wood grain pattern, texture, or other pattern, as shown in FIG. 2. Alternatively, the door facing 30 may have a smooth exterior surface 44. Depressed ovalos or contoured portions may form panels P1-P6. The disclosed composition is moldable into a wide variety of desired configuration. As such, complex contoured areas with relatively high detail may be formed. The door skin 30 may also be a flat sheet, either smooth or with an embossing, such as a wood grain.

In preferred embodiments of the invention, the door facing 30 has a surface finish that is substantially free of imperfections. Also in preferred embodiments, the door facing 30 exhibits relatively low warpage and shrinkage because of the thermal and mechanical properties of the thermoplastic composition, as well as the low orientation of glass fibers achieved through billet placement. Desirable surface characteristics are achieved with a composition having glass fibers of less than 2.54 cm (1.0 inch) in length, preferably 3 mm in length or less.

Although the door facing 30 is shown as a six-panel, substantially rectangular door facing, it should be understood that any door-facing configuration may be formed using the composition. Process variables (e.g., billet placement and number) may be adjusted depending on the particular article configuration being molded. The six-panel door facing 30 is provided for purposes of explanation only, and the invention is not so limited.

The exterior surface 44 and opposing interior surface may be treated to increase the bonding strength of applied paint and/or adhesive. This surface treatment step may be performed, for example, after the door facing 30 has been removed from the press 26 or before the door facing has been subjected to thermoforming. Both the exterior surface 44 and opposing interior surface may be treated to increase the bonding strength of paint, stain, ink, and/or adhesive. Various surface treatment processes may be used, including: plasma treatment, such as open air plasma treatment; sandblasting; chromic acid treatment; flame treatment; corona discharge treatment; surface activation with functional groups, such as oxy-fluorination; and photo-induced surface grafting. The exterior surface 44 and the opposing interior surface may be treated using the same treatment process. Alternatively, it may be desirable to treat only exterior surface 44, or only the interior surface. In addition, one treatment process may be used for treating exterior surface 44, and a different treatment process may be used for treating the interior surface of facing 30. Treatment of exterior surface 44 may improve paintability/stainability when using certain paints/stains. Treatment of the interior surface may improve bond strength, e.g., for bonding to a frame or core component, when using certain adhesives, such as a moisture-cured urethane adhesive. A grain pattern may be imprinted, painted, stained, inked, or other applied on the sanded surface if desirable, preferably through imprinting the wood grain pattern on the sanded surface.

Alternatively, a paper overlay may be adhered to the exterior surface 44. The paper overlay may be applied in lieu of or in addition to a treatment process as described above. For example, a decorative paper overlay having a wood grain pattern and/or texture, or other pattern may be adhered or molded onto the exterior surface 44. The paper overlay may also act as a bonding surface for paint. A suitable paper overlay is a Teslin® synthetic sheet overlay, though other overlays known in the art may also be used.

As another alternative, the exterior surface of the facings may comprise a thin layer of plastic material applied to the exterior surface of the molded composite door structure. The thin layer of plastic material may be applied in any suitable manner. The plastic layer may be formed using ASA plastic or other plastic materials having similar properties. The thickness of the plastic layer may be, for example, about 0.0381 cm (about 0.015 inch) or thinner. For example, when applied in connection with the thermoforming process, the thin layer of plastic may be coextruded with the composite mixture. After the coextrusion operation, the thin sheet and the composite structure are thermoformed to form an exterior three-dimensional door facing. It is also contemplated that the thin layer of plastic material may be applied by lamination.

A high flexural strength of the door facing 30 may be achieved using a composition having a relatively high glass fiber content, or a high-strength polymer component. However, such compositions are relatively expensive. Comparable flexural strength may be achieved with a relatively low glass fiber content, and relatively inexpensive polymer blend, by forming protruding supports on the interior surface of a door facing.

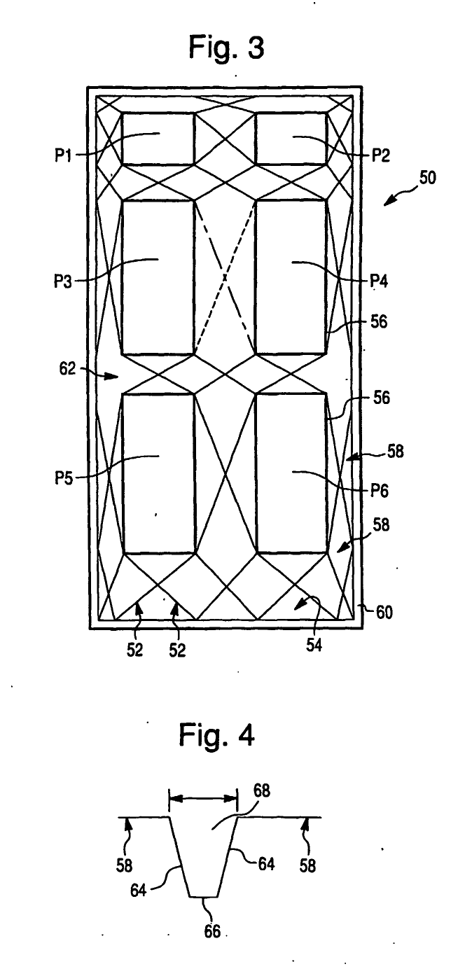

FIG. 3 illustrates an embodiment of a door facing 50 that includes ribs 52 protruding from an interior surface 54 of the door facing 50. The door facing 50, including the ribs 52, is preferably molded from an embodiment of the methods and compositions disclosed herein. The ribs 52 provide additional flexural strength. The pattern and profile of ribs 52 may vary depending on the composition blend used, as well as the number and configuration of panels and/or windows on the door facing 50.

The particular layout of ribs 52 may be determined by identifying areas of warp and low strength on a door facing having the desired configuration, but without any ribs 52 molded therein. The blend of composition used to form the door facing 50 will also affect the rib pattern, e.g., higher strength blends may have fewer low strength areas. For example, compositions having higher glass fiber content may not require as many ribs compared to compositions having lower glass fiber content. Areas of low strength on facing 50 are thereby determined. Ribs 52 are then configured to reinforce the low strength areas. A computer aided engineering program may be used to determine the required rib configuration. Examples of such programs include COSMOS and SOLIDWORKS 3-D modeling software, each of Dassault Systemes (Concord, Mass.).

An exemplary rib design for door facing 50 is shown in FIG. 3. Door facing 50 includes panel portions P1, P2, P3, P4, P5 and P6. Panels P1-P6 are defined by and integral with contoured portions or ovalos 56. Ovalos 56 are also integral with a surrounding major planar surface 58 of interior surface 54. Each ovalo 56 has a rectangular shape with four corners A, B, C and D. For example, panel P1 has corners A, B, C, D. The ribs 52 extend diagonally from ovalo corners of one panel to opposite corners of an adjacent ovalo, forming an ‘X’ configuration on major planar surface 58. For example, a rib 52 extends from corner A of panel P5 to corner C of panel P3. Another rib 52 extends from corner B of panel P5 to corner D of panel P3, and so forth.

The ribs 52 may also be formed around the perimeter of major planar surface 58. However, the interior surface 58 preferably includes a planar periphery 60 having a width of between about 3.81 cm (about 1.5 inch) to about 5.08 cm (about 2.0 inch) between the perimeter ridge and the outer edge of the door. Planar periphery 60 may thereby accommodate stiles and rails during door construction. Lock-block portions 62 devoid of ribs 52 may also be provided on major interior surface 58. Lock-block portions 62 accommodate lock-blocks during door construction. Ribs 52 may be deleted from other portions of major planar surface 58 for accommodating other hardware. Ribs 52 may also be deleted if additional support is not required for a particular application. Such deletions may be made when designing the rib configuration.

The profile of an exemplary rib 52 is best shown in FIG. 4. The rib 52 includes sidewalls 64 that extend from major planar surface 58 to an outer planar surface 66. Outer planar surface 66 is preferably a relatively planar area lying on a plane that is substantially parallel to the plane of major planar surface 58. The sidewalls 64 taper inwardly about 1.0° or less, preferably about 0.5°. The width of the rib 52 at a base portion 68 preferably is between about 0.0762 cm (about 0.03 inch) to about 0.2032 cm (about 0.08 inch). The width of the outer planar surface 66 is preferably less than the width of the base portion 68 due to the taper of the sidewalls 64. The rib 52 has a height, relative to the major planar surface 58, of about 0.64 cm (about 0.25 inch) or less, preferably between about 0.3175 cm (about 0.125) inch and about 0.64 cm (about 0.25 inch).

The ribs 52 preferably have a sufficient height (thickness) for providing structural support. The desired amount of structural support and the resulting height (thickness) of the ribs 52 may vary depending on the composition blend and the door facing configuration. However, excessive rib height should be avoided if such dimensions affect the flow of a foam core during door construction. In addition, excessive dimensions of the ribs 52 should be avoided if the dimensions affect the surface quality of the exterior surface of the door facing 50. For example, the ribs 52 may be visible on the exterior surface if the height of the ribs 52 is excessive because the thermoplastic composition forming the ribs typically cools before other portions of the door facing 50. This cooling tends to cause trace outlines of the ribs 52 on the exterior surface of the door facing 50.

The width and height of ribs 52 are preferably sufficient in dimension to permit the glass fibers to flow into the cavities in the mold die forming the ribs 52. A composition blend having glass fibers having a length of about 2.54 cm (about 1.0 inch) or less, preferably 3 mm or less, may be used for forming the exemplary dimensions of the ribs 52 shown in FIG. 4. It should be understood that the rib configuration may vary depending on the particular composition blend being used. The dimensions of the ribs 52 formed in the door facing 50 should not hinder the flow of the composition during compression. In this way, the flow and alignment of the glass fibers is determined by billet placement, and not rib configuration.

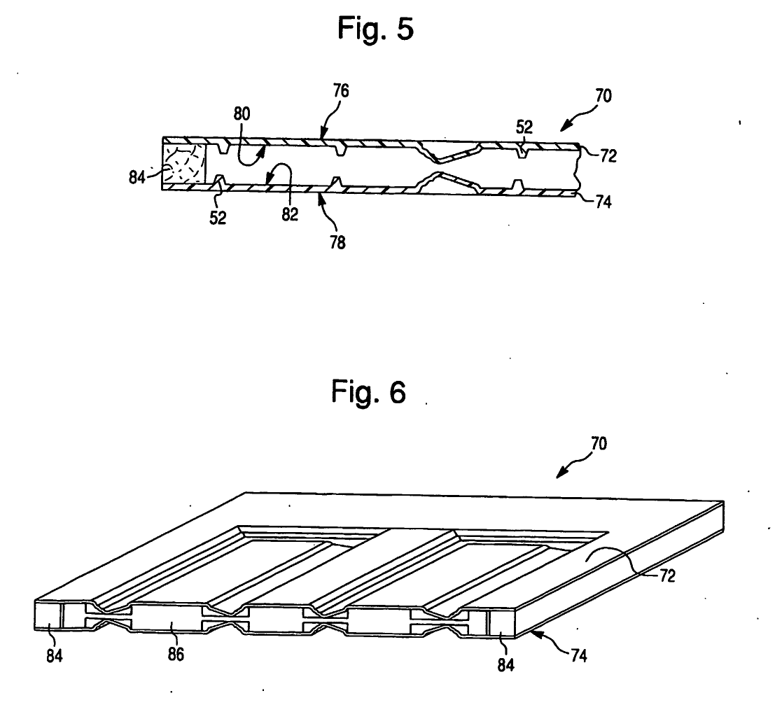

A door 70 according to another embodiment of the present invention is best shown in FIG. 5. The embodied door 70 includes a first thermoplastic door facing 72 and a second thermoplastic door facing 74. The first and second door facings 72, 74 are preferably each formed from the composition embodied herein, although it is within the scope of the invention to form one but not both of the door facings 72, 74 from the composition embodied herein. The door facings 72, 74 include exterior surfaces 76, 78 and interior surfaces 80, 82. The interior surfaces 80, 82 preferably include a pattern of ribs 52, as disclosed above. The exterior surfaces 76, 78 may include a wood grain pattern, texture, other pattern, or paper overlay, as described above. Further, the interior surfaces 80, 82 and the exterior surfaces 76, 78 may be treated as described above.

The composite door may be assembled as follows. The first and second door facings 72, 74 are secured adhesively to opposing sides of a peripheral frame 84. The peripheral frame may be manufactured from a variety of materials, such as wood, or may be manufactured from a composite material similar to the material used in the door facings 72, 74. The door 70 may include a core component 86, as best shown in FIG. 6, such as a foamed polyurethane core or other material having good insulating properties. The core component 86 may be formed in a cavity defined by the frame 84 and door facings 72, 74 during manufacture. Alternatively, the core component 86 may be provided as a preformed insert.

In accordance with preferred embodiments of the invention, the door 70 exhibits excellent thermal and mechanical properties. For example, the door 70 preferably maintains its structural integrity with minimal warping under conditions wherein the temperature difference between the exterior surface 76 of the first door facing 72 and the exterior surface 78 of the second door facing 74 is about 38° C. (about 100° F.) or more.

Advantageously, composite door structures such as door facings constructed in accordance with the present invention are dimensionally stable in response to temperature variations. The door facings are also constructed to undergo a minimum of expansion and contraction, making the facings less likely to delaminate from the frame. This dimensional stability results in composite door structures that are suitable for use in association with storm doors.

The invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. A composite door skin structure, comprising:
about 40 weight percent to about 80 weight percent thermoplastic polymer;
up to about 30 weight percent glass fibers randomly oriented; and
at least one member selected from the group consisting of not less than about 5 weight percent mineral filler and not less than about 10 weight percent organic fibrous additive.

2. The composite door skin structure of claim 1, wherein the composite door structure comprises a molded door facing.

3. The composite door skin structure of claim 1, wherein the molded door facing has a rectangular periphery and substantially planar interior and exterior surfaces facing away from one another.

4. The composite door skin structure of claim 1, wherein the exterior surface comprises a plurality of panels.

5. The composite door skin structure of claim 3, wherein the interior surface comprises a plurality of reinforcing ribs.

6. The composite door skin structure of claim 5, wherein the reinforcing ribs extend diagonally between adjacent panels.

7. The composite door skin structure of claim 1, wherein the thermoplastic polymer constitutes about 50 weight percent to about 80 weight percent of the composite door structure.

8. The composite door skin structure of claim 1, wherein the thermoplastic polymer comprises impact grade polypropylene.

9. The composite door skin structure of claim 1, wherein the thermoplastic polymer comprises polystyrene.

10. The composite door skin structure of claim 1, wherein the glass fibers constitute about 5 weight percent to about 30 weight percent of the composite door structure.

11. The composite door skin structure of claim 1, wherein the glass fibers constitute about 10 weight percent to about 30 weight percent of the composite door structure.

12. The composite door skin structure of claim 1, wherein the glass fibers have a length of between about 3 mm to about 7.62 cm.

13. The composite door skin structure of claim 1, wherein the mineral filler constitutes about 10 weight percent to about N 40 weight percent of the composite door structure.

14. The composite door skin structure of claim 1, wherein the mineral filler constitutes about 20 weight percent to about 30 weight percent of the composite door structure.

15. The composite door skin structure of claim 1, wherein the mineral filler comprises mica.

16. The composite door skin structure of claim 1, wherein the organic fibrous additive constitutes about 10 weight percent to about 50 weight percent of the composite door structure.

17. The composite door skin structure of claim 1, wherein the polymer has a melt flow index at 230° C. of between about 0.5 g/10 min to about 500 g/10 min.

18. The composite door skin structure of claim 1, wherein the molded door facing has a coefficient of thermal expansion of between about 20×10⁻⁶/° C. to about 40×10⁻⁶/° C.

19. The composite door skin structure of claim 1, wherein the molded door facing has a stiffness between about 400,000 to about 2.0 million pounds per square inch (psi).

20. The composite door skin structure of claim 1, wherein the molded door facing has an impact strength of between about 1.5 foot pounds to about 7.5 foot pounds.

21. The composite door skin structure of claim 1, wherein the molded door facing has a toughness of between about 5.0 foot pounds to about 25.0 foot pounds.

22. A door comprising:
a frame having opposite first and second sides;
first and second molded door skins fixed to the first and second sides, respectively, at least one of which molded door skins comprising the molded door skin of claim 1; and
a core component situated between the first and second molded door skins.

23. A door comprising:
a frame having opposite first and second sides;
first and second molded door skins fixed to the first and second sides, respectively, each of the first and second molded door skins respectively comprising the molded door facing of claim 1; and
a core component situated between the first and second molded door skins.

24. A method of making the composite door structure of claim 1, comprising:
extruding a composition comprising about 40 weight percent to about 80 weight percent thermoplastic polymer, up to about 30 weight percent glass fibers, and at least one member selected from the group consisting of not less than about 5 weight percent mineral filler and not less than about 10 weight percent organic fibrous additive; and
forming the extruded composition into the composite door skin structure of claim 1 wherein the glass fibers are arranged in a random orientation in the composite door skin.

25. The method of claim 24, wherein said forming step comprises compression molding the extruded composition.

26. The method of claim 24, wherein said forming step comprises thermoforming the extruded composition.

27. The method of claim 24, wherein the thermoforming step comprises pressure forming.

28. A method of making a door, comprising:
extruding a composition comprising about 40 weight percent to about 80 weight percent thermoplastic polymer, up to about 30 weight percent glass fibers, and at least one member selected from the group consisting of a not less than about 5 weight percent mineral filler and not less than about 10 weight organic fibrous additive;
forming the extruded composition into the composite door skin structure of claim 1, the composite door structure comprising a first door skin in which the glass fibers are arranged in a random orientation; and
assembling the first door skin, a second door skin, a foam core, and a peripheral frame into a door in which the first and second door skins are fixed on opposite sides of the peripheral frame and the foam core is situated between the first and second door skins.

29. A method of making a door, comprising:
extruding a composition comprising about 40 weight percent to about 80 weight percent thermoplastic polymer, up to about 30 weight percent glass fibers, and at least one member selected from the group consisting of not less than about 5 weight percent mineral filler and not less than about 10 weight percent organic fibrous additive;
forming the extruded composition into a plurality of the composite door skin structures of claim 1, the composite door skin structures comprising a first door skin and a second door skin each having randomly oriented glass fibers; and
assembling the first door skin, the second door skin, a foam core, and a peripheral frame into a door in which the first and second door skins are fixed on opposite sides of the peripheral frame and the foam core is situated between the first and second door skins.
